(19) United States
(12) Patent Application Publication
(10) Pub. No.: US 2015/0059895 A1
(43) Pub. Date: Mar. 5, 2015

(54) VEHICLE FUELING MANIFOLD ASSEMBLY

(71) Applicant: dHybrid Systems, LLC, St. George, UT (US)

(72) Inventor: Trevor Milton, Santa Clara, UT (US)

(73) Assignee: dHybrid Systems, LLC, St. George, UT (US)

(21) Appl. No.: 14/015,141

(22) Filed: Aug. 30, 2013

(51) Int. Cl. F17C 13/04; B60K 15/01

(52) U.S. Cl. CPC F17C 13/04; B60K 15/013; B60K 2015/016; F17C 2205/0146
USPC 137/624.27

(57) ABSTRACT

A manifold assembly includes a manifold block having a female inlet, at least one outlet, and a gas passageway between the female inlet and the at least one outlet. The manifold assembly further includes a check valve that is sealable against the female inlet and arranged at least partially within the gas passageway between the female inlet and the at least one outlet such that in the absence of pressurized gas within the female inlet, the check valve is sealed against the female inlet, and in response to the introduction of pressurized gas within the female inlet, the check valve recedes from the female inlet to fluidly connect the female inlet and the at least one outlet.

### TECHNICAL FIELD

This disclosure relates to manifold assemblies used to fuel multiple on-board vehicle fuel tanks.

### BACKGROUND

Natural gas may be used as a fuel for certain vehicles. Unlike gasoline, natural gas is typically stored in several on-board tanks (as opposed to a single on-board tank). Each of these tanks needs to be filled when refueling.

### SUMMARY

A fuel delivery system includes a manifold assembly. The manifold assembly includes a manifold block having a female inlet configured to receive a male fueling nozzle and at least one outlet, and defining a gas passageway between the female inlet and the at least one outlet. The manifold assembly further includes a check valve configured to be sealable against the female inlet and arranged at least partially within the gas passageway between the female inlet and the at least one outlet such that in the absence of pressurized gas within the female inlet, the check valve is sealed against the female inlet, and in response to the introduction of pressurized gas within the female inlet, the check valve recedes from the female inlet to fluidly connect the female inlet and the at least one outlet.

A manifold assembly includes a manifold block defining an inlet port, at least one outlet port, and a gas passageway between the inlet port and the at least one outlet port. The manifold assembly further includes an inlet having opposing ends and a check valve sealed against the one of the ends and configured to open from the inlet, in response to an increase in pressure within the inlet caused by pressurized gas entering the inlet, to fluidly connect the inlet and at least one outlet port. The one of the ends is disposed within the inlet port and the other of the ends is disposed outside of the manifold block and configured to receive a fueling nozzle.

A manifold assembly includes a manifold block defining an inlet port, at least one outlet port, and a gas passageway between the inlet port and the at least one outlet port. The manifold assembly further includes a check valve arranged at least partially within the gas passageway and configured such that the check valve opens to fluidly connect the inlet port and at least one outlet port in response to pressurized gas entering from the inlet port, closes once the pressurized gas stops entering from the inlet port, and remains closed in response to pressurized gas entering the manifold block from the at least one outlet port.

### BRIEF DESCRIPTION OF THE DRAWINGS

FIG. 1 is a front perspective view of a manifold assembly.

FIG. 2 is an exploded front perspective view of the manifold assembly of FIG. 1.

FIG. 3 is a rear perspective view, in cross-section, of the manifold block of FIG. 1.

FIG. 4 is a front view, in cross-section, of the manifold assembly of FIG. 1.

FIGS. 5-7 are front views, in cross-section, of the valve assemblies of FIG. 4.

FIGS. 8-10 are side views, in cross-section, of the manifold assembly of FIG. 1.

FIGS. 11-12 are top views, in cross-section, of the manifold assembly FIG. 1.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As mentioned earlier, natural gas may be stored in several tanks on-board a vehicle. Such tanks are typically filled sequentially. That is, a first tank is filled followed by a second tank, then a third tank, etc. The process of refueling generates heat as temperature can increase with pressure: as the rate of change of pressure increases, the rate of change of temperature increases. The rate at which a tank is filled via conventional refueling procedures is therefore limited by the ability of the tank to dissipate the heat generated during the refueling procedures. Such limits can extend refueling times—frustrating drivers and increasing operation costs.

Filling several tanks simultaneously can reduce refueling times relative to conventional techniques. Distributing gas among several tanks slows the rate of change of pressure increase (and therefore the rate of change of temperature increase) in any one tank. Filling station flow velocities can therefore be increased. Conventional on-board natural gas inlets, however, can restrict filling station flow velocities because valving, such as check valves, is located within the inlets.

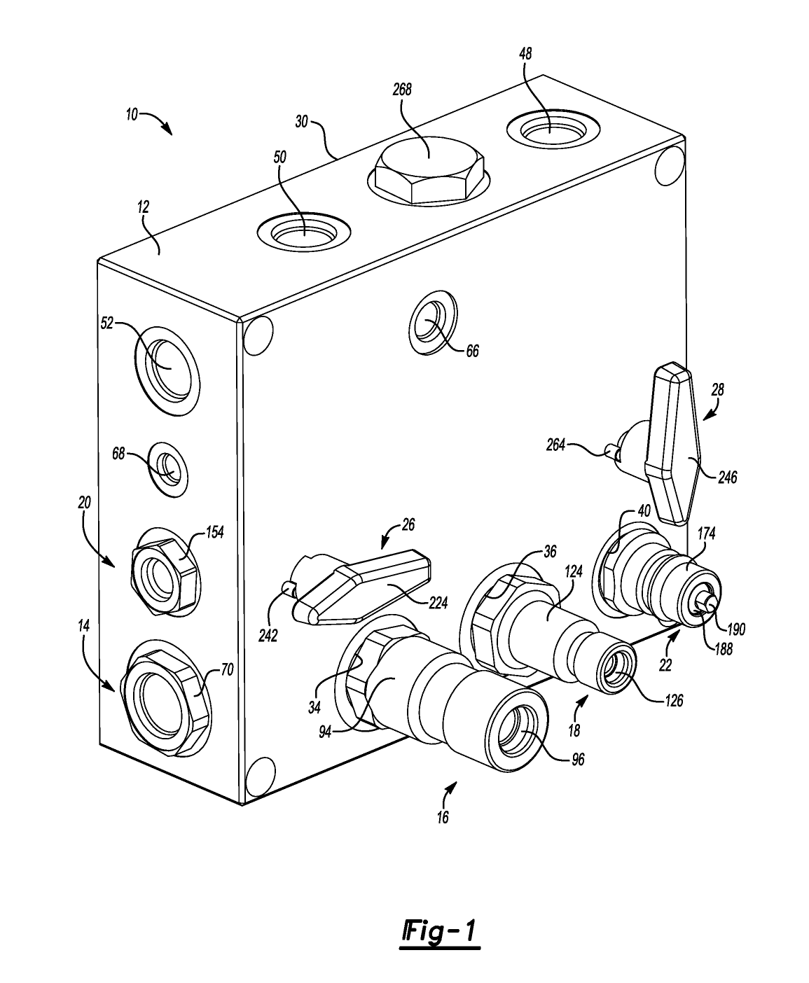

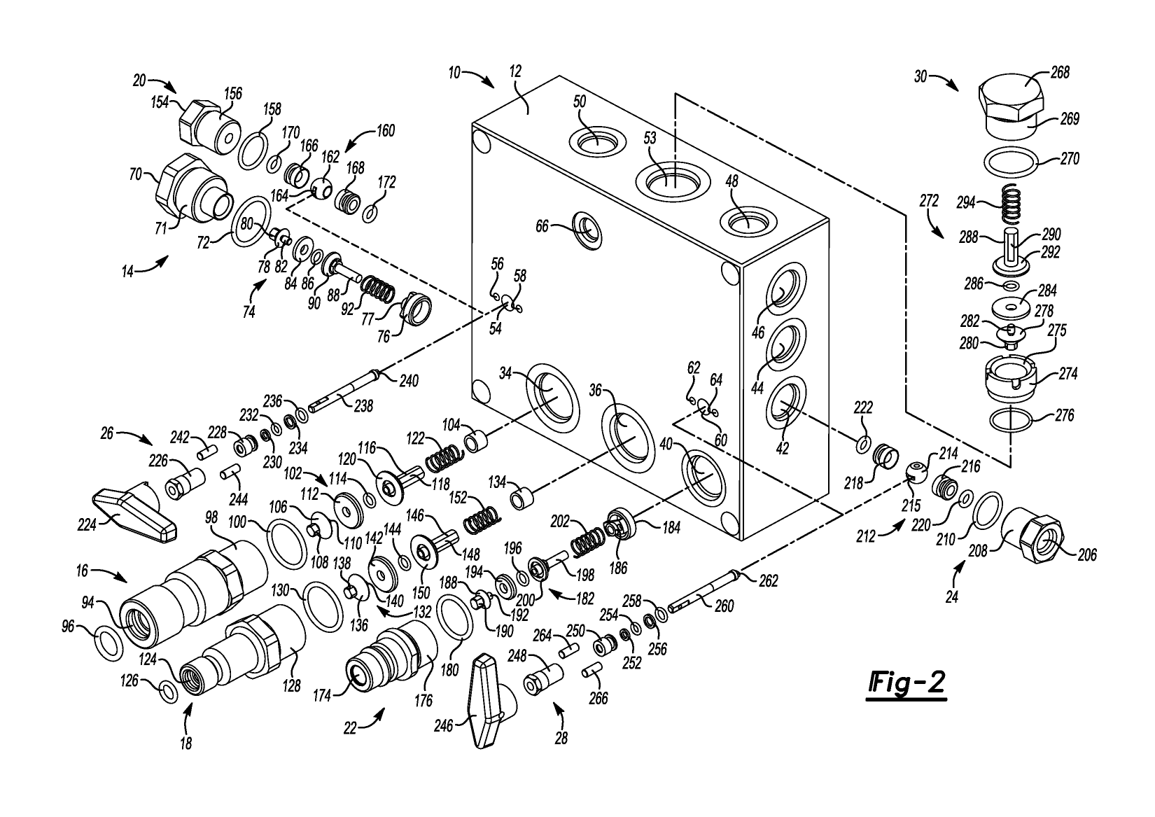

Referring to FIGS. 1 and 2, a manifold assembly 10 includes a manifold block 12, inlet valve assemblies 14, 16, 18, outlet valve assemblies 20, 22, 24, handle assemblies 26, 28, and a check valve assembly 30. The manifold block 12 includes inlet ports 32, 34, 36, outlet ports 38, 40, 42, 44, 46, 48, 50, 52, and port 53. The manifold block 12 also includes handle passageway 54 and post holes 56, 58, handle passageway 60 and post holes 62, 64, pressure gauge port 66, and pressure sensor port 68. In certain examples, the manifold block 12 is made from aluminum. As such, it can dissipate heat associated with compressed gas flowing therethrough—permitting faster flow rates relative to conventional filling apparatus. Other materials, however, may also be used.

As the names suggest, pressure gauge port 66 may be outfitted with a gauge to monitor pressure within the manifold block 12 and pressure sensor port 68 may be outfitted with a sensor to monitor pressure within the manifold block 12.

The inlet valve assemblies 14, 16, 18 are associated with the inlet ports 32, 34, 36 respectively. The outlet valve assemblies 20, 22, 24 are associated with the outlet ports 38, 40, 42 respectively. The check valve assembly 30 is associated with the port 53. Handle assemblies 26, 28 are associated with the handle passageways 54, 60.

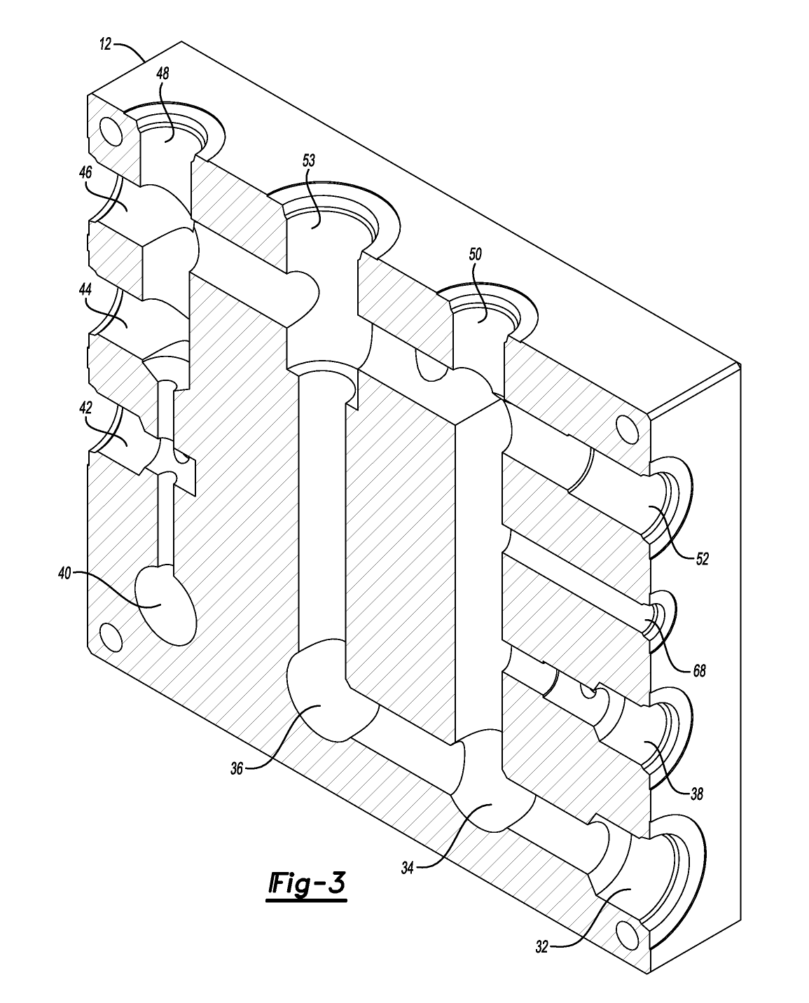

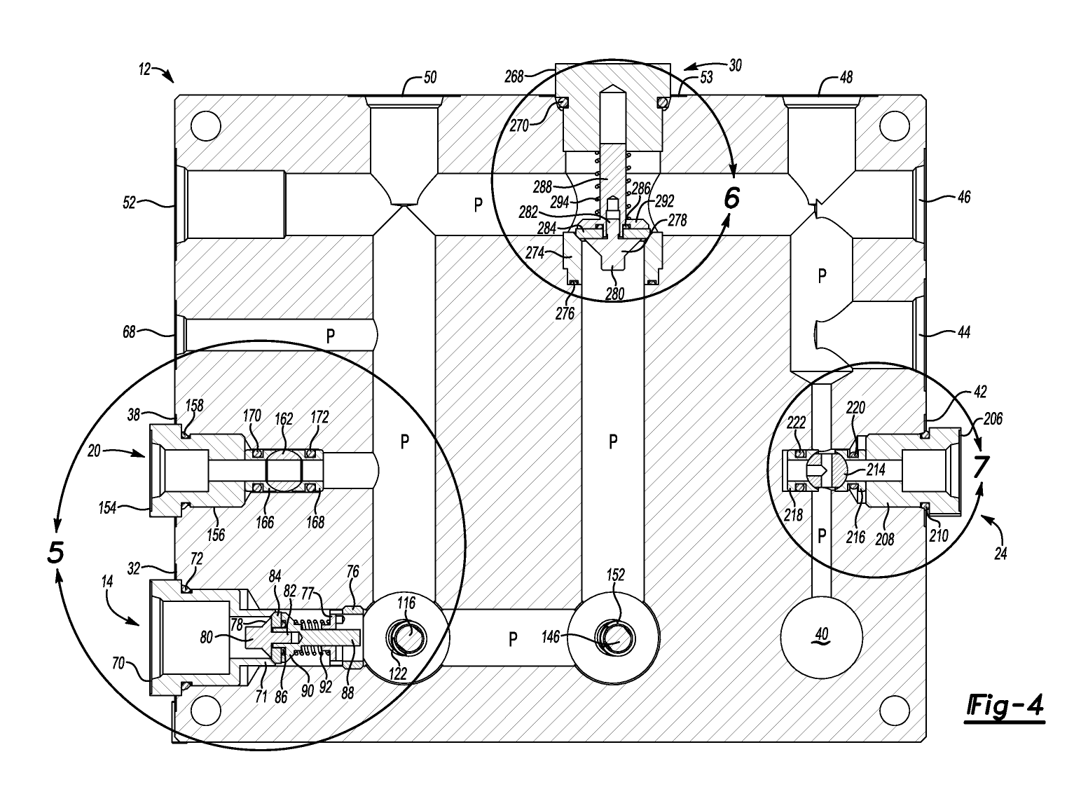

With further reference to FIGS. 3 and 4, any of the inlet ports 32, 34, 36 may be fluidly connected with any of the outlet ports 38, 40, 42, 44, 46, 48, 50, 52 via a network of internal passageways, P, defined by the manifold block 12 provided that the valve assemblies 14, 16, 18, 20, 22, 24, 30 are properly activated as discussed in greater detail below. Moreover, the layout illustrated is but one example. Other passageway and inlet/outlet configurations are, of course, also contemplated. An alternative manifold assembly, for example, may have only a single inlet or a single outlet.

Referring again to FIG. 2, the inlet valve assembly 14 includes an inlet 70 with a hat portion 71, an O-ring 72, a check valve assembly 74, and a base 76 with a raised eyelet 77. The check valve assembly 74 includes a head 78 with a crown 80 and nipple 82, a disk 84, an O-ring 86, a stem 88 with a platform 90, and a spring 92.

The inlet valve assembly 16 includes an inlet 94 with an O-ring 96 and a hat portion 98, an O-ring 100, a check valve assembly 102, and a spacer 104. The check valve assembly 102 includes a head 106 with a crown 108 and nipple 110, a disk 112, an O-ring 114, a stem 116 with a flattened portion 118 and platform 120, and a spring 122.

The inlet valve assembly 18 includes an O-ring 126 and a hat portion 128, an O-ring 130, a check valve assembly 132, and a spacer 134. The check valve assembly 132 includes a head 136 with a crown 138 and nipple 140, a disk 142, an O-ring 144, a stem 146 with a flattened portion 148 and platform 150, and a spring 152. In other examples, the check valve assembly 132 (or any other check valve assembly described herein) may comprise a spring loaded ball or plate. Still other check valve assemblies are also contemplated.

The outlet valve assembly 20 includes an outlet 154 with a hat portion 156, an O-ring 158, and a ball valve assembly 160 (shown in the open position). The ball valve assembly 160 includes a ball valve 162 with a keyway 164, valve retainers 166, 168, and O-rings 170, 172.

The outlet valve assembly 22 includes an outlet 174 with a hat portion 176, an O-ring 180, a check valve assembly 182, and a base 184 with a raised eyelet 186. The check valve assembly 182 includes a head 188 with a crown 190 and nipple 192, a disk 194, an O-ring 196, a stem 198 with a platform 200, and a spring 202.

The outlet valve assembly 24 includes an outlet 206 with a hat portion 208, an O-ring 210, and a ball valve assembly 212 (shown in the closed position). The ball valve assembly 212 includes a ball valve 214, valve retainers 216, 218, and O-rings 220, 222.

The handle assembly 26 includes a handle 224, a guide 226, a stem spacer 228, a washer 230, an O-ring 232, a washer 234, an O-ring 236, and a stem 238 with a key 240. Posts 242, 244, which are received by post holes 56, 58 respectively, limit movement of the handle 224 between its open and closed position.

The handle assembly 28 includes a handle 246, a guide 248, a stem spacer 250, a washer 252, an O-ring 254, a washer 256, an O-ring 258, and a stem 260 with a key 262. Posts 264, 266, which are received by post holes 62, 64 respectively, limit movement of the handle 246 between its open and closed position.

The check valve assembly 30 includes a plug 268 with a hat portion 269, an O-ring 270, a check valve assembly 272, a base 274, and an O-ring 276. The check valve assembly 272 includes a head 278 with a crown 280 and nipple 282, a disk 284, an O-ring 286, a stem 288 with a flattened portion 290 and platform 292, and a spring 294. In other examples, check valve assemblies associated with inlets may be arranged similar to that described with reference to check valve assembly 30. That is, they may be mounted from a side of the manifold block 12 opposite that of the corresponding inlet with a plug similar to the plug 268 or the like. Other arrangements are also contemplated.

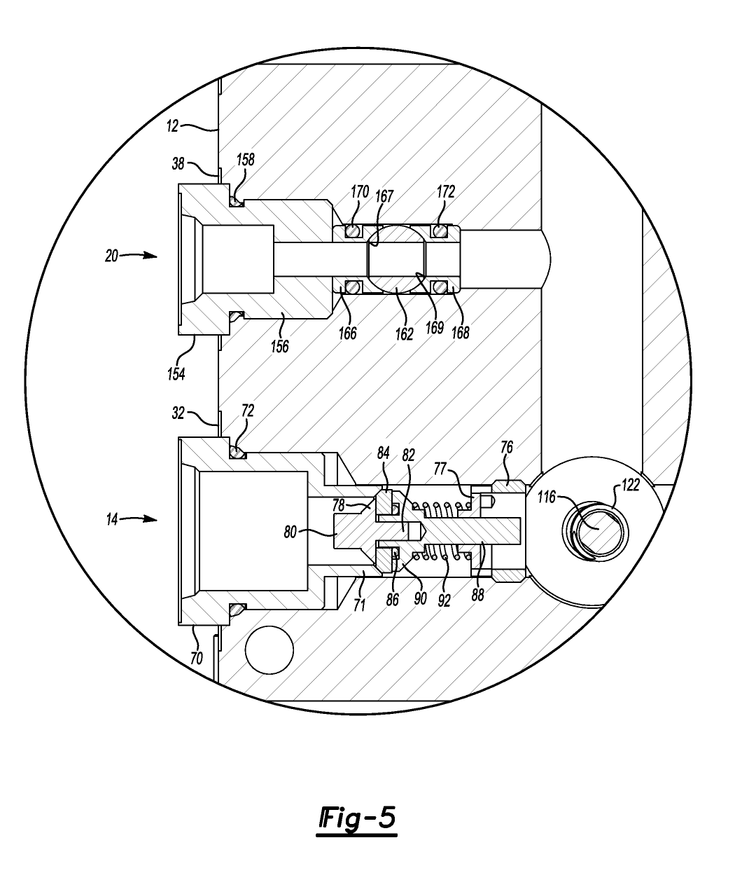

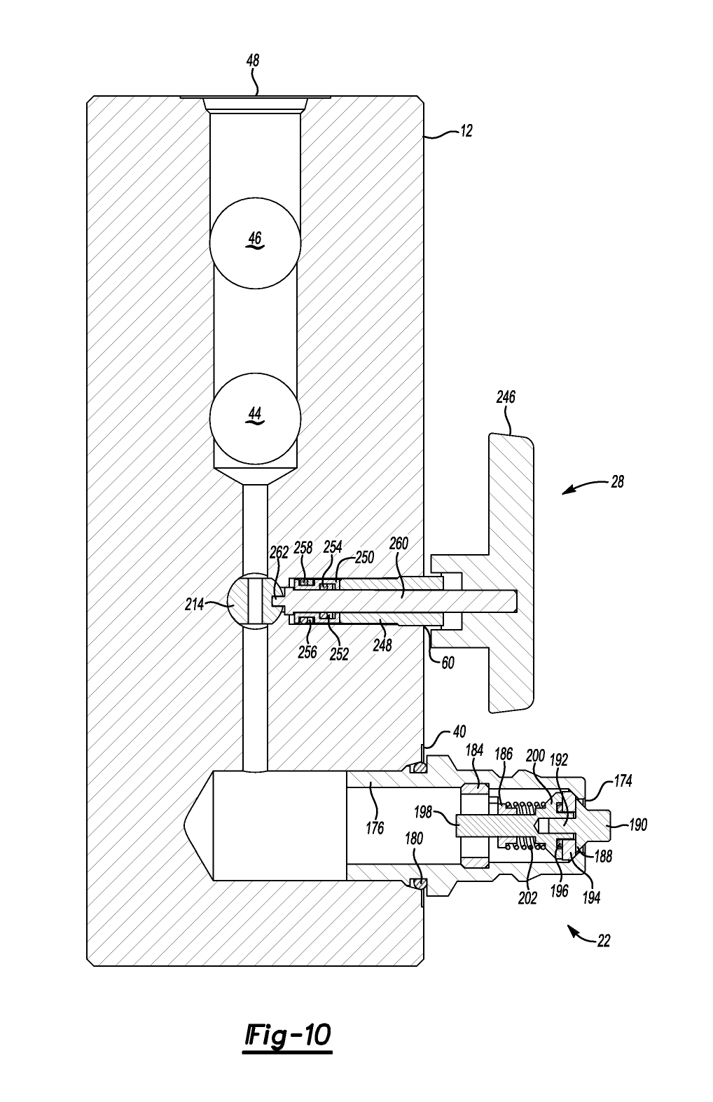

With reference to FIG. 5, the inlet 70 is situated within the inlet port 32 with the hat portion 71 oriented away from the inlet port 32. The inlet 70 is circumferentially sealed with the manifold block 12 via the O-ring 72. As apparent to those of ordinary skill, the inlet 70 does not house a check valve assembly (compared with, for example, the outlet valve assembly 22, see FIG. 10) and therefore defines an unobstructed chamber when the check valve assembly 74 is open.

The base 76 is seated within the manifold block 12 with the eyelet 77 oriented toward the inlet port 32. The stem 88 is positioned within the eyelet 77 so as to permit travel of the stem 88 therein as the check valve assembly 74 moves between open and closed positions. The platform 90 includes receiving portions for the nipple 82 and the O-ring 86. The nipple 82 and disk 84 are mounted with the platform 90. The O-ring 86 seals the connection between the disk 84 and platform 90. The spring 92 is threaded over the stem 88 and positioned between the base 76 and the platform 90. The spring 92 holds the check valve assembly 74 against the hat portion 71 to close the inlet 70. Sufficient pressure within the inlet 70 (caused, for example, by gas from a male refueling nozzle) will cause the head 78 to move away from the hat portion 71 (compressing the spring 92) to open the inlet 70. When the pressure subsides, the spring 92 (acting against the base 76 and platform 90) will return the check valve assembly 74 to its closed position.

The outlet 154 is situated within the outlet port 38 with the hat portion 156 oriented away from the outlet port 38. The outlet 154 is circumferentially sealed with the manifold block 12 via the O-ring 158.

The valve retainers 166, 168 include hemispherical retainer portions 167, 169 respectively. The valve retainer 168 is seated within the manifold block 12 with the hemispherical retainer portion 169 oriented toward the outlet port 38. The valve retainer 166 is seated against the hat portion 156 with the hemispherical retainer portion 167 oriented away from the outlet port 38. The valve retainers 166, 168 are circumferentially sealed with the manifold block 12 via O-rings 170, 172 respectively. The ball valve 162 (shown in the open position) is disposed between the hemispherical retainer portions 167, 169 and therefore able to rotate in place by action of the handle assembly 26 as discussed in more detail below. If the ball valve 162 were rotated 90 degrees clockwise, it would be in the closed position.

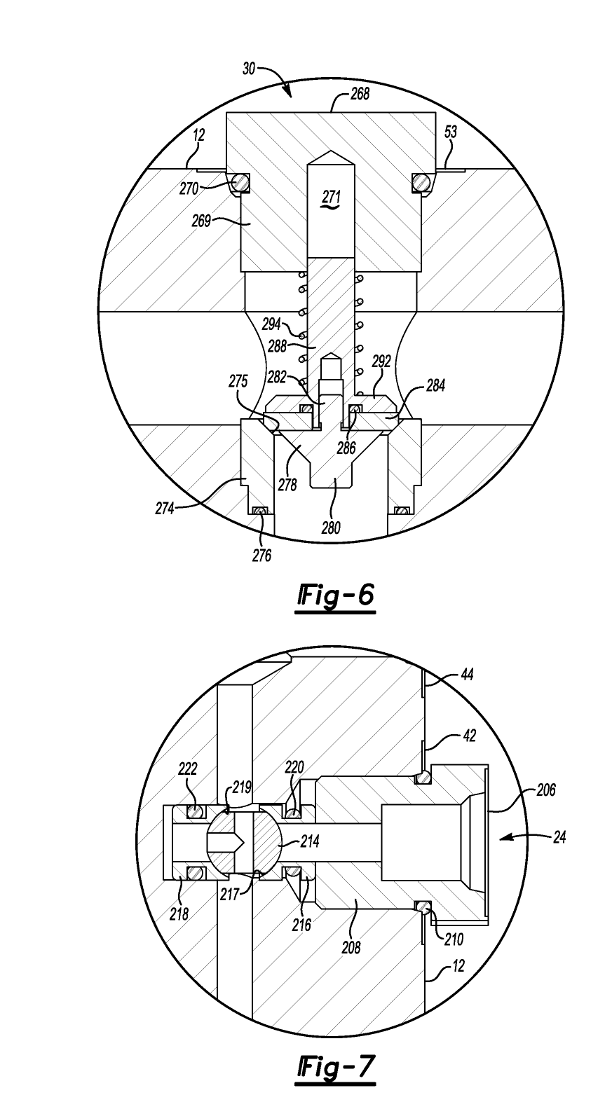

With reference to FIG. 6, the plug 268 is situated within the port 53 with the hat portion 269 oriented away from the port 53. The plug 268 is circumferentially sealed with the manifold block 12 via the O-ring 270. The plug 268 further defines a recessed portion 271 in axial registration with and configured to receive the stem 288.

The base 274 includes a cup portion 275 and is seated within the manifold block 12 with the cup portion 275 oriented toward the port 53. The base 274 is sealed with the manifold block 12 via the O-ring 276.

The stem 288 is positioned within the recessed portion 271 so as to permit travel of the stem 288 therein as the check valve assembly 272 moves between open and closed positions. The platform 292 includes receiving portions for the nipple 282 and the O-ring 286. The nipple 282 and disk 284 are mounted with the platform 292. The O-ring 286 seals the connection between the disk 284 and platform 292. The spring 294 is threaded over the stem 288 and positioned between the hat portion 269 and the platform 292. The spring 294 holds the check valve assembly 272 against the cup portion 275 to close the base 274. Sufficient pressure within the base 274 (caused, for example, by gas from one of the inlet ports 32, 36, 36) will cause the head 278 to move away from the cup portion 275 (compressing the spring 294 and pushing the stem 288 further into the recessed portion 271) to open the base 274. The flattened portion 290 (see FIG. 2) of the stem 288 permits gas trapped within the recessed portion 271 to escape as the stem 288 travels therein. When the pressure subsides, the spring 294 (acting against the hat portion 269 and platform 292) will return the check valve assembly 272 to its closed position.

With reference to FIG. 7, the outlet 206 is situated within the outlet port 42 with the hat portion 208 oriented away from the outlet port 42. The outlet 206 is circumferentially sealed with the manifold block 12 via the O-ring 210.

The valve retainers 216, 218 include hemispherical retainer portions 217, 219 respectively. The valve retainer 216 is seated within the manifold block 12 with the hemispherical retainer portion 217 oriented toward the outlet port 42. The valve retainer 216 is seated against the hat portion 208 with the hemispherical retainer portion 219 oriented away from the outlet port 42. The valve retainers 216, 218 are circumferentially sealed with the manifold block 12 via O-rings 220, 222 respectively. The ball valve 214 (shown in the closed position) is disposed between the hemispherical retainer portions 217, 219 and therefore able to rotate in place by action of the handle assembly 28 as discussed in more detail below. If the ball valve 214 were rotated 90 degrees for example, it would be in the open position.

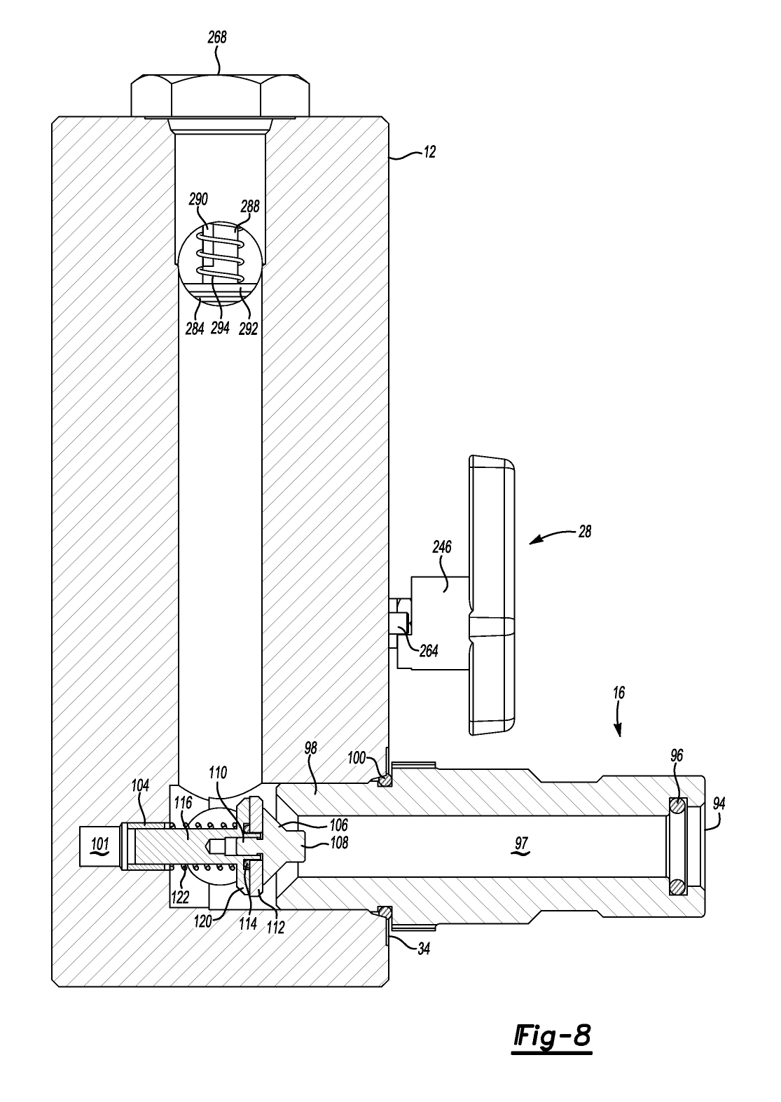

With reference to FIG. 8, the inlet 94 is situated within the inlet port 34 with the hat portion 98 oriented away from the inlet port 34. The inlet 94 includes the O-ring 96 at its tip to seal against any male fueling nozzle inserted therein and defines a passageway 97 therethrough. The inlet 94 is circumferentially sealed with the manifold block 12 via the O-ring 100. As apparent to those of ordinary skill, the inlet 94 does not house a check valve assembly.

The manifold block 12 defines a recessed portion 101 in axial registration with the passageway 97 and configured to receive the stem 116. The spacer 104 is seated within the recessed portion 101 to guide travel of the stem 116 therein as the check valve assembly 102 (see FIG. 2) moves between open (as shown) and closed positions.

The platform 120 includes receiving portions for the nipple 110 and the O-ring 114. The nipple 110 and disk 112 are mounted with the platform 120. The O-ring 114 seals the connection between the disk 112 and platform 120. The spring 122 is threaded over the stem 116 and positioned between the spacer 104 and the platform 120. The spring 122 holds the check valve assembly 102 against the hat portion 98 to close the inlet 94. Sufficient pressure within the passageway 97 (caused, for example, by gas from a male fueling nozzle inserted therein) will cause the head 106 to move away (or recede) from the hat portion 98 (compressing the spring 122 and pushing the stem 116 further into the recessed portion 101) to open the inlet 94. The flattened portion 118 (see FIG. 2) of the stem 116 permits gas trapped within the recessed portion 101 to escape as the stem 116 travels therein. When the pressure subsides, the spring 122 (acting against the spacer 104 and platform 120) will return the check valve assembly 102 to its closed position.

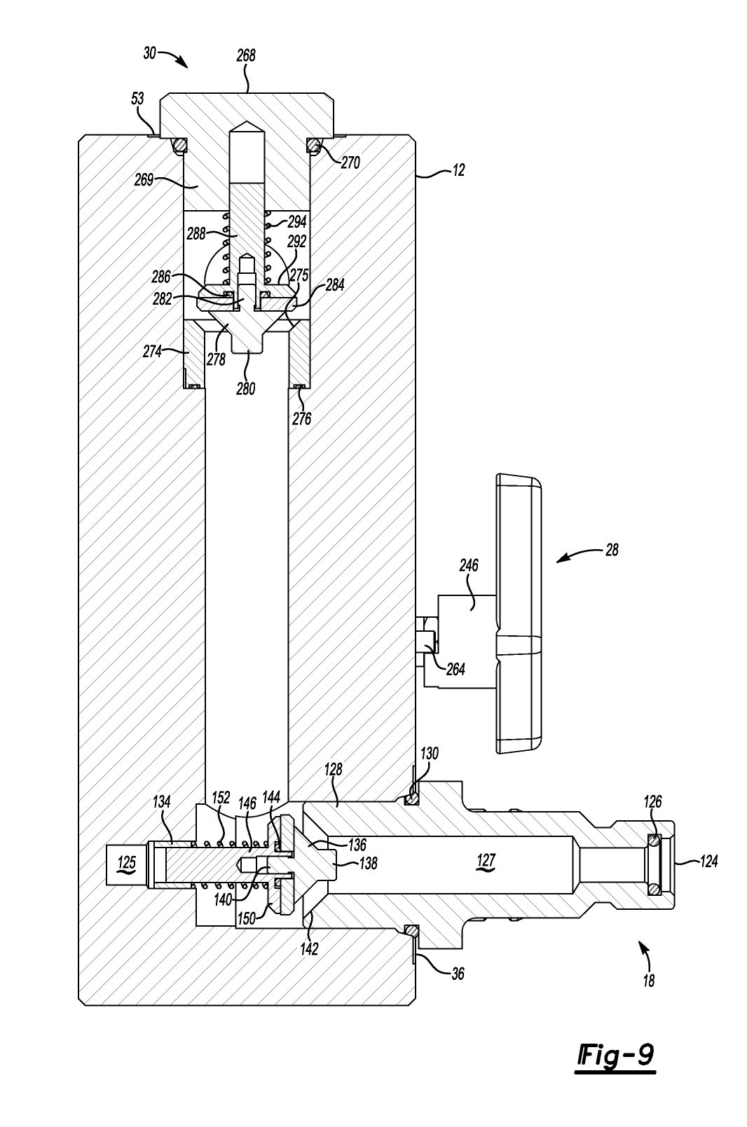

With reference to FIG. 9, the inlet 124 is situated within the inlet port 36 with the hat portion 128 oriented away from the inlet port 36. The inlet 124 includes the O-ring 126 at its tip to seal against any male fueling nozzle inserted therein and defines a passageway 127 therethrough. The inlet 124 is circumferentially sealed with the manifold block 12 via the O-ring 130. As apparent to those of ordinary skill, the inlet 124 does not house a check valve assembly.

The manifold block 12 defines a recessed portion 125 in axial registration with the passageway 127 and configured to receive the stem 146. The spacer 134 is seated within the recessed portion 125 to guide travel of the stem 146 therein as the check valve assembly 132 moves between open (as shown) and closed positions.

The platform 150 includes receiving portions for the nipple 140 and the O-ring 144. The nipple 140 and disk 142 are mounted with the platform 150. The O-ring 144 seals the connection between the disk 142 and platform 150. The spring 152 is threaded over the stem 146 and positioned between the spacer 134 and the platform 150. The spring 152 holds the check valve assembly 132 against the hat portion 128 to close the inlet 124. Sufficient pressure within the passageway 127 (caused, for example, by gas from a male fueling nozzle inserted therein) will cause the head 136 to move away from the hat portion 128 (compressing the spring 152 and pushing the stem 146 further into the recessed portion 125) to open the inlet 124. The flattened portion 148 (see FIG. 2) of the stem 146 permits gas trapped within the recessed portion 125 to escape as the stem 146 travels therein. When the pressure subsides, the spring 152 (acting against the spacer 134 and platform 150) will return the check valve assembly 132 to its closed position.

With reference to FIG. 10, the outlet 174 is situated within the outlet port 40 with a hat portion 176 oriented away from the outlet port 40. The outlet 174 is circumferentially sealed with the manifold block 12 via the O-ring 180. The base 184 is seated within the outlet 174 with the eyelet 186 oriented toward a tip of the outlet 174. The stem 198 is positioned within the eyelet 186 so as to permit travel of the stem 198 therein as the check valve assembly 182 moves between open and closed positions. The platform 200 includes receiving portions for the nipple 192 and the O-ring 196. The nipple 192 and disk 194 are mounted with the platform 200. The O-ring 196 seals the connection between the disk 194 and platform 200. The spring 202 is threaded over the stem 198 and positioned between the base 184 and the platform 200. The spring 202 holds the check valve assembly 182 against the tip of the outlet 174 to close the outlet 174. Sufficient force applied to the crown 190 will cause the head 188 to move away from the tip (compressing the spring 202) to open the outlet 174. When the force subsides, the spring 202 (acting against the base 184 and platform 200) will return the check valve assembly 182 to its closed position.

The guide 248, stem spacer 250, washer 252, O-ring 254, washer 256, and O-ring 258 are threaded over the stem 260. This assembly is positioned within the handle passageway 60 such that the key 262 interfaces with the key way 215. The O-rings 254, 258 seal the stem 260 within the handle passageway 60. The handle 246 is fitted to the guide 248. Rotations of the handle 246 will thus be transmitted to the ball valve 214 via the stem 260.

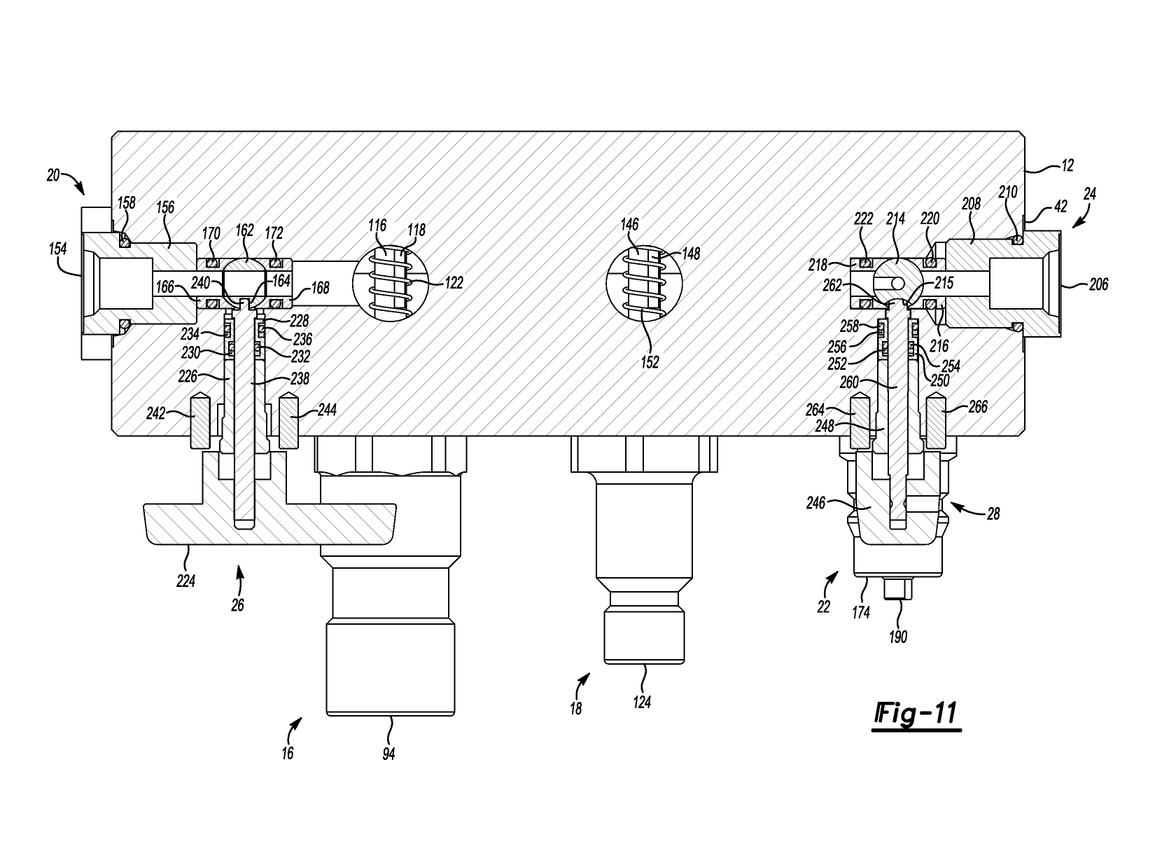

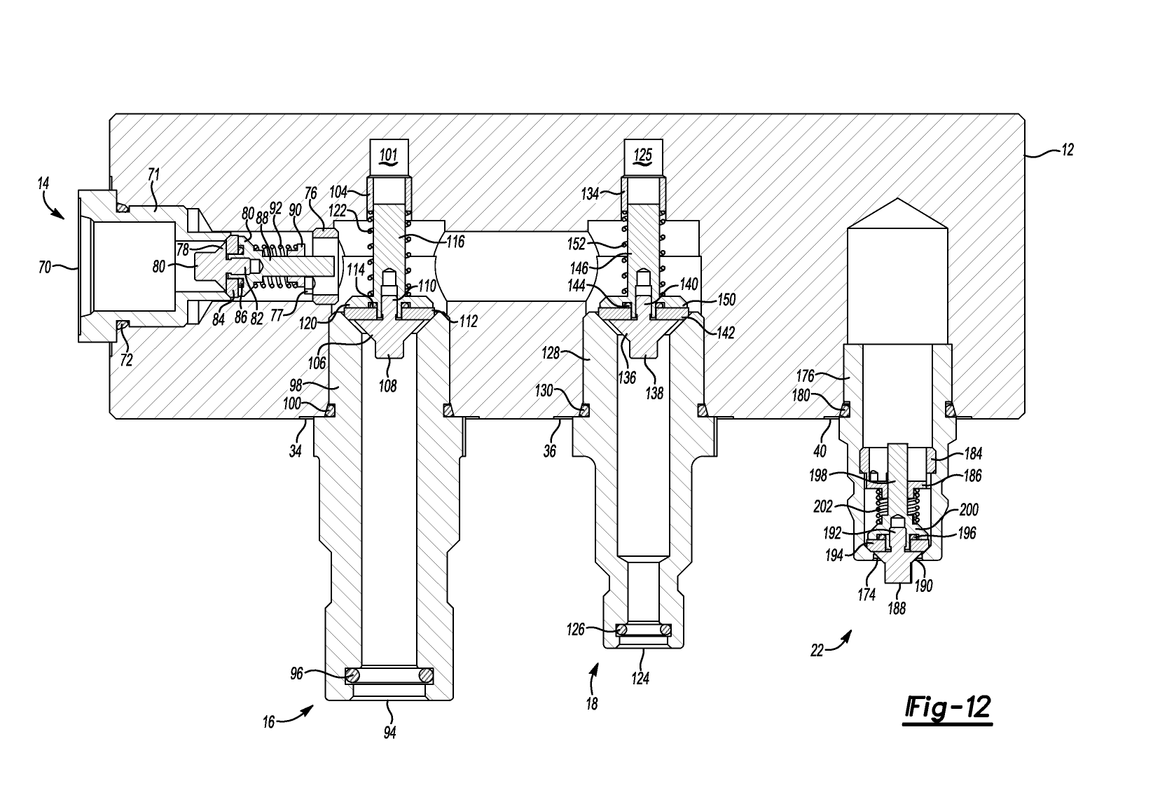

With reference to FIG. 11, the guide 226, stem spacer 228, washer 230, O-ring 232, washer 234, and O-ring 236 are threaded over the stem 238. This assembly is positioned within the handle passageway 54 such that the key 240 mates with the key way 164. The O-rings 232, 236 seal the stem 238 within the handle passageway 54. The handle 224 is fitted to the guide 226. Rotations of the handle 224 will thus be transmitted to the ball valve 162 via the stem 238.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A fuel delivery system comprising:
a manifold assembly including a manifold block (i) having a female inlet configured to receive a male fueling nozzle and at least one outlet and (ii) defining a gas passageway between the female inlet and the at least one outlet, wherein the manifold assembly further includes a check valve configured to be sealable against the female inlet and arranged at least partially within the gas passageway between the female inlet and the at least one outlet such that in the absence of pressurized gas within the female inlet, the check valve is sealed against the female inlet, and in response to the introduction of pressurized gas within the female inlet, the check valve recedes from the female inlet to fluidly connect the female inlet and the at least one outlet.

2. The system of claim 1, wherein the female inlet has opposing ends, wherein one of the ends is disposed within the manifold block and the other of the ends is disposed outside of the manifold block, and wherein the female inlet defines an unobstructed flow chamber between the opposing ends when the check valve is open.

3. The system of claim 2, wherein the check valve is further configured to be sealable against the one of the ends of the female inlet.

4. The system of claim 1, wherein the manifold assembly further includes another check valve arranged at least partially within the gas passageway between the female inlet and the least one outlet such that when the pressurized gas flows from the female inlet into the gas passageway, the another check valve, in response, moves to fluidly connect the female inlet and the at least one outlet.

5. The system of claim 4, wherein the another check valve is further arranged at least partially within the gas passageway between the female inlet and the at least one outlet such that when pressurized gas flows from the at least one outlet into the manifold block, the another check valve remains closed.

6. The system of claim 1, wherein the at least one check valve includes a stem and wherein the manifold block further defines a stem chamber configured to receive the stem.

7. The system of claim 1, wherein the at least one check valve includes a flat sided stem, wherein the manifold block further defines a stem chamber configured to receive the flat sided stem, and wherein the flat sided stem is configured to permit gas within the stem chamber to escape from the stem chamber as the flat sided stem moves into the stem chamber.

8. A manifold assembly comprising:
a manifold block defining an inlet port, at least one outlet port, and a gas passageway between the inlet port and the at least one outlet port;
an inlet having opposing ends, wherein one of the ends is disposed within the inlet port and the other of the ends is disposed outside of the manifold block and configured to receive a fueling nozzle; and
a check valve sealed against the one of the ends and configured to open from the inlet, in response to an increase in pressure within the inlet caused by pressurized gas from the fueling nozzle entering the inlet, to fluidly connect the inlet and at least one outlet port.

9. The manifold assembly of claim 8, wherein the check valve is further configured such that a portion of the check valve is disposed within the inlet when the check valve is sealed against the one of the ends and the portion is disposed outside the inlet when the check valve opens from the inlet.

10. The manifold assembly of claim 8, wherein the inlet defines an unobstructed flow chamber between the opposing ends when the check valve is open.

11. The manifold assembly of claim 8, wherein the check valve includes a stem and wherein the manifold block further defines a stem chamber configured to receive the stem.

12. The manifold assembly of claim 8, wherein the check valve includes a flat sided stem, wherein the manifold block further defines a stem chamber configured to receive the flat sided stem, and wherein the flat sided stem is configured to permit gas within the stem chamber to escape from the stem chamber as the flat sided stem moves into the stem chamber.

13. The manifold assembly of claim 8, wherein the manifold assembly further includes another check valve arranged at least partially within the gas passageway between the inlet and the least one outlet port such that when pressurized gas flows from the inlet into the gas passageway, the check valve, in response, moves to fluidly connect the inlet and the at least one outlet port.

14. The manifold assembly of claim 13, wherein the another check valve is further arranged at least partially within the gas passageway between the inlet and the at least one outlet port such that when pressurized gas flows from the at least one outlet port into the manifold block, the another check valve remains closed.

15. A manifold assembly comprising:
a manifold block defining an inlet port, at least one outlet port, and a gas passageway between the inlet port and the at least one outlet port; and
a check valve arranged at least partially within the gas passageway and configured such that the check valve (i) opens to fluidly connect the inlet port and at least one outlet port in response to pressurized gas entering from the inlet port, (ii) closes once the pressurized gas stops entering from the inlet port, and (iii) remains closed in response to pressurized gas entering the manifold block from the at least one outlet port.

16. The manifold assembly of claim 15 further comprising a plug attached with the manifold block, wherein the check valve includes a stem and wherein the plug defines a stem chamber configured to receive the stem.

17. The manifold assembly of claim 15, wherein the check valve includes a stem and wherein the manifold block further defines a stem chamber configured to receive the stem.

18. The manifold assembly of claim 15, wherein the check valve includes a flat sided stem, wherein the manifold block further defines a stem chamber configured to receive the flat sided stem, and wherein the flat sided stem is configured to permit gas within the stem chamber to escape from the stem chamber as the flat sided stem moves into the stem chamber.
